(19) United States
(12) Patent Application Publication
(10) Pub. No.: US 2025/0136503 A1
(43) Pub. Date: May 1, 2025

(54) METHOD FOR THE PRODUCTION OF A CEMENTITIOUS MATERIAL

(71) Applicants: BUZZI S.P.A., Casale Monferrato (Alessandria) (IT); HINFRA S.R.L., Casale Monferrato (Alessandria) (IT)

(72) Inventors: Fulvio CANONICO, Torino (IT); Livio CAPELLI, Rosignano Monferrato (Alessandria) (IT); Federica BERTOLA, Etterbeek (BE); Stefano GUANZIROLI, Erba (Como) (IT)

(73) Assignees: BUZZI S.P.A., Casale Monferrato (Alessandria) (IT); HINFRA S.R.L., Casale Monferrato (Alessandria) (IT)

(21) Appl. No.: 18/837,202

(22) PCT Filed: Feb. 8, 2023
(86) PCT No.: PCT/IB2023/051119

§ 371 Date: Aug. 9, 2024

(30) Foreign Application Priority Data
Feb. 9, 2022 (IT) 102022000002309

(51) Int. Cl. C04B 7/32; C04B 11/30; C04B 111/00

(52) U.S. Cl. CPC C04B 7/323; C04B 11/30; C04B 2111/00646

(57) ABSTRACT

A method for producing cementitious material involves mixing 100 parts by weight of a first mixture with 8 to 12 parts by weight of water to obtain a first slurry. The first mixture has, in a percentage by weight, 20 to 25% of a cement selected from Portland cement, limestone cement, slag cement, pozzolanic cement, composite cement and mixtures thereof, 0 to 6% of calcium sulfate, 65 to 80% of inert material, and 1 to 4% of SO₃. A second slurry is obtained by mixing 100 parts by weight of a second mixture with 30 to 45 parts of water. The second mixture has, in a percentage by weight, 85 to 100% of a cement selected from calcium sulfoaluminate (CSA) cement, aluminous cement and mixtures thereof, 0 to 15% of inert material, and 5 to 13% of SO₃. The second mixture is added to the first mixture with a weight ratio between 0.10 and 0.20.

The present invention relates to the field of cementitious materials containing aggregates, such as concrete and mortar.

In many building applications it is necessary to use cementitious materials which develop high mechanical resistance in the short term. For these applications, mortars and concretes are typically used that contain special cements different from the more conventional Portland cements, in particular sulfoaluminate (CSA) cements which develop significant mechanical resistance just a few hours after casting.

As known, Portland cements must meet the requirements of the harmonized European standard EN 197-1, which provides for a maximum SO₃ content of 4.5%.

On the other hand, sulfoaluminate cements are hydraulic binders having a high content—typically between 20% and 80% by weight—in Yeelimite, i.e. a mineralogical phase consisting of calcium sulfoaluminate (C4A3$). Other mineralogical phases usually present are dicalcium silicate, anhydrite, and tricalcium aluminate. Specifically, the presence of sulfates, such as gypsum or anhydrite, allows for the development of high mechanical resistance.

In the applications in question, attention must be paid to complying with the contradictory needs of rapid hardening of the mortar or concrete, so as to reach the required resistance in the short pre-set time, and their maintenance in a fluid state for the entire time in which they are subjected to working.

In particular, the construction industry requires that the so-called “rapid” mortars and concretes remain workable for a sufficiently long time, so as to avoid the risk that, for example, they harden in the cement mixer due to hitches or unexpected events that occur during the mixing process.

In practice, however, it is found that the development of high mechanical resistance in the short term, although in itself a relatively easy goal to achieve, leads to a rapid reduction in workability.

An object of the present invention is therefore to provide cementitious materials capable of developing high mechanical resistance in the short term, without being subject to an equally rapid decline in their workability.

This object is achieved by virtue of a method for the production of a cementitious material, comprising the steps of:
mixing 100 parts by weight of a first mixture with 8 to 12 parts by weight of water so as to obtain a first slurry, said first mixture comprising from 20 to 25% by weight of a cement chosen from the group consisting of Portland cement, limestone cement, slag cement, pozzolanic cement, composite cement and mixtures thereof, from 0 to 6% by weight of calcium sulfate, and from 65 to 80% by weight of inert material, and having a SO₃ content by weight from 1 to 4%,
after the obtainment of the first slurry, mixing 100 parts by weight of a second mixture with 30 to 45 parts of water so as to obtain a second slurry, said second mixture comprising from 85 to 100% by weight of a cement chosen from the group consisting of calcium sulfoaluminate (CSA) cement, aluminous cement and mixtures thereof, and from 0 to 15% by weight of inert material, and having a SO₃ content from 5 to 13% by weight, and
adding said second slurry to the first slurry with a ratio of 0.10 to 0.20 by weight between the second slurry and the first slurry, and mixing so as to obtain said cementitious material.

The latter is capable of developing high mechanical resistance in the short term, without being subject to an equally rapid decline in its workability.

It is possible that the second mixture further comprises up to 2% by weight of a retardant, up to 0.5% by weight of a lithium salt, and/or up to 2% by weight of CaO, and/or that at least one of the first and second mixtures further comprises up to 3% by weight of a fluidizer.

Advantageously, the CSA cement used has a C₄A₃$ content greater than 30% by weight.

In preferred embodiments of the method of the invention, the first mixture comprises 2 to 6% by weight of anhydrous calcium sulfate, and/or the second mixture comprises 1 to 5% by weight of inert material.

Further objects of the present invention are a concrete and respectively a mortar obtained with the method described above. In particular, such a concrete may be used by pouring into a formwork or by extrusion.

An exemplary embodiment of a method according to the invention is now provided for merely illustrative and non-limiting purposes, wherein all the indicated percentages are to be considered by weight unless expressly indicated otherwise.

### EXAMPLE

A first mixture consisting of the components listed in Table I and having a SO₃ content by weight equal to 2.7% is mixed with 175 g of water for 45 minutes, so as to obtain a first slurry.

TABLE I

| | Quantity | % on | % on | % on total |
|---|---|---|---|---|
| Component | (g) | dry basis | total dry | binder |
| CEM I 52.5 R | 420 | 22.63 | 20.46 | 59.8 |
| Anhydrite | 70 | 3.77 | 3.41 | 10.0 |
| CaO | 7 | 0.38 | 0.34 | 1.0 |
| Normal sand | 1350 | 72.74 | 65.77 | — |
| Sika P22 liquid fluidizer | 9 | 0.48 | 0.44 | 1.3 |

A second mixture consisting of the components listed in Table II is mixed with 75 g of water for 5 minutes, so as to obtain a second slurry. The CSA cement or binder of the second mixture contains 60% by weight of C₄A₃$. The SO₃ content of the second mixture is equal to 8.3% by weight.

TABLE II

| | Quantity | % on dry | % on | % on total |
|---|---|---|---|---|
| Component | (g) | slurry | total dry | binder |
| Sulfoaluminate binder | 190 | 96.64 | 9.26 | 27.0 |
| Lithium carbonate | 0.7 | 0.36 | 0.03 | 0.1 |
| Citric acid | 1.4 | 0.71 | 0.07 | 0.2 |
| Sika P22 liquid fluidizer | 4.5 | 2.29 | 0.22 | 0.6 |

The second mixture is added to the first mixture and mixed for a period of time equal to 5 minutes until a homogeneous cementitious material is obtained, which is suitably fluid so that it may be easily poured into a formwork. The evolution of the compressive strength of the poured cementitious material over time is described in Table III.

TABLE III

| | |
|---|---|
| Compressive strength 2 h (MPa) | 18.5 |
| Compressive strength 3 h (MPa) | 25.3 |
| Compressive strength 24 h (MPa) | 37.5 |
| Compressive strength 7 days (MPa) | 61.7 |
| Compressive strength 28 days (MPa) | 74.8 |

Without prejudice to the principle underlying the invention, details of implementation and embodiments may vary widely with respect to that which has been disclosed purely by way of example, without thereby departing from the scope of the invention as defined in the appended claims. In particular, the above mixtures may also contain any conventionally used additive, such as fluidizers, retarders, expanders and the like, alone or in combination.

1. A method for producing a cementitious material, the method comprising:
mixing 100 parts by weight of a first mixture with 8 to 12 parts by weight of water to obtain a first slurry, said first mixture comprising from 20 to 25% by weight of a cement selected from the group consisting of Portland cement, limestone cement, slag cement, pozzolanic cement, composite cement and mixtures thereof, from 0 to 6% by weight of calcium sulfate, and from 65 to 80% by weight of inert material, and having a SO₃ content by weight from 1 to 4%,
after obtaining the first slurry, mixing 100 parts by weight of a second mixture with 30 to 45 parts of water to obtain a second slurry, said second mixture comprising from 85 to 100% by weight of a cement selected from the group consisting of calcium sulfoaluminate (CSA) cement, aluminous cement and mixtures thereof, and from 0 to 15% by weight of inert material, and having a SO₃ content from 5 to 13% by weight, and
adding said second slurry to the first slurry with a ratio of 0.10 to 0.20 by weight between the second slurry and the first slurry, and mixing to obtain said cementitious material.

2. The method of claim 1, wherein said second mixture further comprises up to 2% by weight of a retarder, up to 0.5% by weight of a lithium salt, and/or up to 2% by weight of CaO.

3. The method of claim 1, wherein at least one of said first and second mixtures further comprises up to 3% by weight of a fluidizer.

4. The method of claim 1, wherein said CSA cement has a C₄A₃$ content of more than 30% by weight.

5. The method of claim 1, wherein said first mixture comprises from 2 to 6% by weight of calcium sulfate.

6. The method of claim 1, wherein said second mixture comprises from 1 to 5% by weight of inert material.

7. A mortar obtainable by the method of claim 1.

8. A concrete obtainable by the method of claim 1.

9. The concrete of claim 8, wherein the concrete is used by casting into a formwork or by extrusion.
